(19) United States
(12) Patent Application Publication
(10) Pub. No.: US 2003/0007307 A1
(43) Pub. Date: Jan. 9, 2003

(54) Apparatus for removing static electricity using high-frequency high AC voltage

(75) Inventors: Tong Young Lee, Kyungki-do (KR); Yeo Song Yun, Kyungki-do (KR); Jae Hun Oh, Kyungki-do (KR); Eui Kyeong Choi, Kyungki-do (KR)

Correspondence Address: LOWE HAUPTMAN GOPSTEIN GILMAN & BERNER, LLP, Suite 310, 1700 Diagonal Road, Alexandria, VA, 22314, US

(73) Assignee: Samsung Electro-Mechanics Co., Ltd.

(21) Appl. No.: 10/135,523

(22) Filed: May 1, 2002

(30) Foreign Application Priority Data
Jul. 3, 2001 (KR) 2001-39421

(51) Int. Cl. H01H 1/00

(52) U.S. Cl. 361/232

(57) ABSTRACT

The present invention relates to a static electricity removal apparatus which is capable of raising an alternating rate at which ions are generated according to the speed of the charged objects using a high-frequency high AC voltage, resulting in an increase in a static electricity removing efficiency. The static electricity removal apparatus comprises at least one discharge electrode assembly including a plurality of needle-shaped electrodes aligned with each other, each of the needle-shaped electrodes generating ions using a corona discharge under the condition that it is provided with a high-frequency high AC voltage, a ground electrode for inducing ion generation by each of the needle-shaped electrodes, and a high-frequency high voltage generation unit connected to the discharge electrode assembly, the voltage generation unit generating the high-frequency high AC voltage to be provided to each of the needle-shaped electrodes of the discharge electrode assembly.

### BACKGROUND OF THE INVENTION

1. Field of the Invention

The present invention relates to an apparatus for removing static electricity using a high-frequency high alternating current (AC) voltage, and more particularly to a static electricity removal apparatus which is capable of generating ions at an alternating rate according to a moving speed of a charged object using a high-frequency high AC voltage, thereby enhancing a static electricity removing efficiency.

2. Description of the Related Art

Generally, in a condenser fabrication process, a high insulation film (for example, a polypropylene film or the like) is subjected to coating with a high dielectric material while being fed at a high speed using a roller. During this process, when friction and separation occur between the film and the roller guiding the film, there may be generated a high-level electrostatic voltage (a maximum of 20,000V), resulting in a degradation in a work efficiency. For this reason, there has been used an apparatus for removing static electricity.

The conventional static electricity removal apparatus may be, for example, an ionizer using a commercial AC voltage or a direct current (DC) pulse voltage. However, in the case where the insulation film is treated at a high speed, even after the static electricity is removed by the ionizer, there may still remain a residual electrostatic voltage of a maximum of 7,000V. This shows that a static electricity removal efficiency of the conventional static electricity removal apparatus is low.

To enhance the static electricity removal efficiency, it is required to momentarily remove the static electricity on the basis of a moving speed of a charged object. However, ions are generated at a low alternating rate in the conventional static electricity removal apparatus because it uses the commercial AC voltage or the DC pulse voltage, resulting in an insufficient efficiency of static electricity removal.

In this regard, there has been a request for a new static electricity removal apparatus which is capable of achieving an alternating rate at which ions are generated according to a moving speed of a charged object.

### SUMMARY OF THE INVENTION

Therefore, the present invention has been made in view of the above problems, and it is an object of the present invention to provide a static electricity removal apparatus suitable for charged objects moving at a high speed, which is capable of raising an alternating rate at which ions are generated according to the speed of the charged objects using a high-frequency high AC voltage, resulting in an increase in a static electricity removing efficiency.

In accordance with the present invention, the above and other objects can be accomplished by the provision of a static electricity removal apparatus comprising at least one discharge electrode assembly including a plurality of needle-shaped electrodes aligned with each other, each of the needle-shaped electrodes generating ions using a corona discharge under the condition that it is provided with a high-frequency high AC voltage; a ground electrode spaced apart from the discharge electrode assembly at a certain interval, the ground electrode inducing ion generation by each of the needle-shaped electrodes under the condition that the discharge electrode assembly is provided with the high-frequency high AC voltage; and a high-frequency high voltage generation unit connected to the discharge electrode assembly, the voltage generation unit generating the high-frequency high AC voltage to be provided to each of the needle-shaped electrodes of the discharge electrode assembly.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a cross sectional view of a static electricity removal apparatus using a high-frequency high AC voltage in accordance with an embodiment of the present invention;

FIG. 2 is a cross sectional view of a static electricity removal apparatus using a high-frequency high AC voltage in accordance with another embodiment of the present invention;

FIGS. 3a and 3b are side and plan views of discharge electrode assemblies of the static electricity removal apparatus of FIG. 1;

FIGS. 4a and 4b are side and plan views of a discharge electrode assembly of the static electricity removal apparatus of FIG. 2;

FIG. 5 is a block diagram showing the construction of a high-frequency high voltage generation unit of the static electricity removal apparatus of FIG. 1 or FIG. 2 according to the present invention;

FIG. 6a and 6b are side views of a needle-shaped electrode of the static electricity removal apparatus of FIG. 1 or FIG. 2 and a distribution, around the discharge needle, of lines of electric force;

FIG. 7 shows a detailed pulse width modulation (PWM) circuit in the high-frequency and voltage generation unit of FIG. 5 according to the present invention; and

FIG. 8 shows a detailed ion balance circuit in the high-frequency AC voltage generation unit of FIG. 5 according to the present invention.

### DESCRIPTION OF THE PREFERRED EMBODIMENTS

The present invention provides a static electricity removal apparatus using a high-frequency high AC voltage, in which a high-frequency high AC voltage of a frequency of 17 KHz and a maximum voltage of 7000 Volt is generated and then applied to at least one discharge electrode assembly. Hereinafter, a description will be given of the static electricity removal apparatus on the basis of two embodiments, air-blowing and bar types.

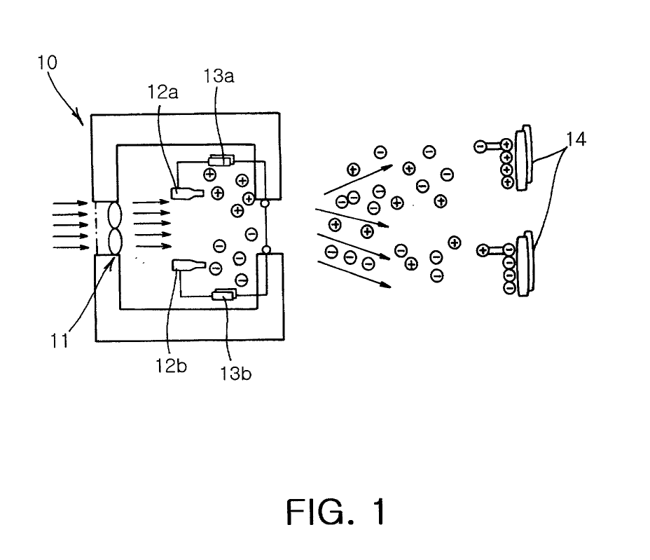

FIG. 1 is a cross sectional view of a static electricity apparatus of an air-blowing type in accordance with a preferred embodiment of the present invention.

As shown in this drawing, the static electricity removal apparatus 10 according to the present invention comprises a fan 11, first and second discharge electrode assemblies 12a and 12b. The removal apparatus 10 further comprises first and second high-frequency high voltage generation units 13a and 13b for applying a high-frequency high voltage to the discharge electrode assemblies 12a and 12b. The fan 11 is arranged behind the first and second discharge electrode assemblies 12a and 12b. Each of the discharge electrode assemblies 12a and 12b has a plurality of needle-shaped electrodes which are aligned with each other. Further, the discharge electrode assemblies 12a and 12b are respectively placed in upper and lower parts of the removal apparatus 10 to be opposed to each other.

The first and second high-frequency high voltage generation units 13a and 13b which are the most important feature of the present invention act to generate a high-frequency high voltage and apply the generated high-frequency high voltage to each of the needle-shaped electrodes of each of the discharge electrode assemblies 12a and 12b such that a corona discharge occurs around each of the needle-shaped electrodes to generate ions. There is an advantage in that ions are generated at a high alternating rate in the above manner due to the voltage of a high frequency. Finally, the generated ions are moved to charged objects 14 by the fan 11 arranged behind the first and second discharge electrode assemblies 12a and 12b, thereby being capable of effectively removing static electricity on the charged objects 14 even while the charged objects 14 move at high speeds.

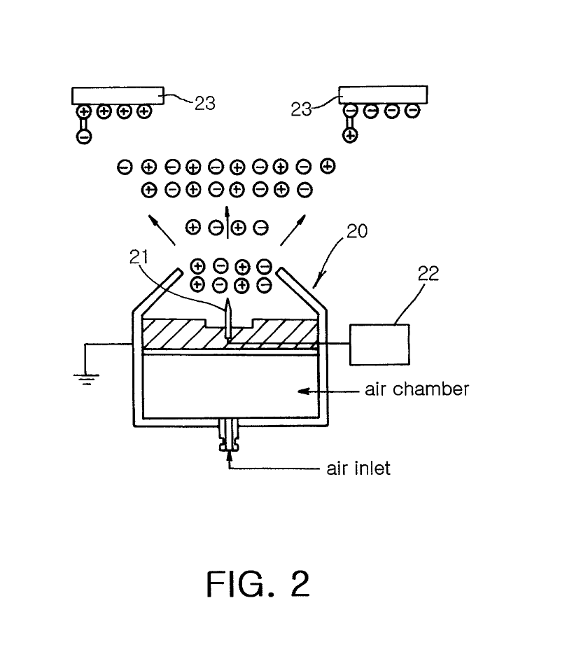

FIG. 2 is a cross sectional view of a static electricity removal apparatus of a bar type which is capable of performing a static electricity removal operation using force of a pressurized air instead of force of a fan in order to reduce its size in accordance with another preferred embodiment of the present invention. As shown in this drawing, the bar type removal apparatus 20 comprises an air chamber defined in such a way as to communicate with an air inlet defined on a lower surface thereof. The bar type removal apparatus 20 is configured to supply air to the air chamber through the air inlet until air pressure within the air chamber becomes relatively high and to move ions to a charged objects 23 using force of the air pressure which has become relatively high.

The bar type static electricity removal apparatus 20 further comprises a discharge electrode assembly 21 placed between the air inlet and an ion outlet, which includes a plurality of needle-shaped electrodes aligned with each other and spaced at regular intervals, and a high-frequency high voltage generation unit 22 for applying a high-frequency high voltage to each of the needle-shaped electrodes of the discharge electrode assembly 21.

The high-frequency high voltage generation unit 22 generates a high-frequency high AC voltage of a frequency of 17KHz and a maximum voltage of 7000 Volt according to the present invention. Then, the voltage generation unit 22 applies the generated high-frequency high AC voltage to each of the needle-shaped electrodes of the discharge electrode assembly 21 such that a corona discharge occur using the applied AC voltage to generate ions, thereby being capable of achieving a high alternating rate of ion generation.

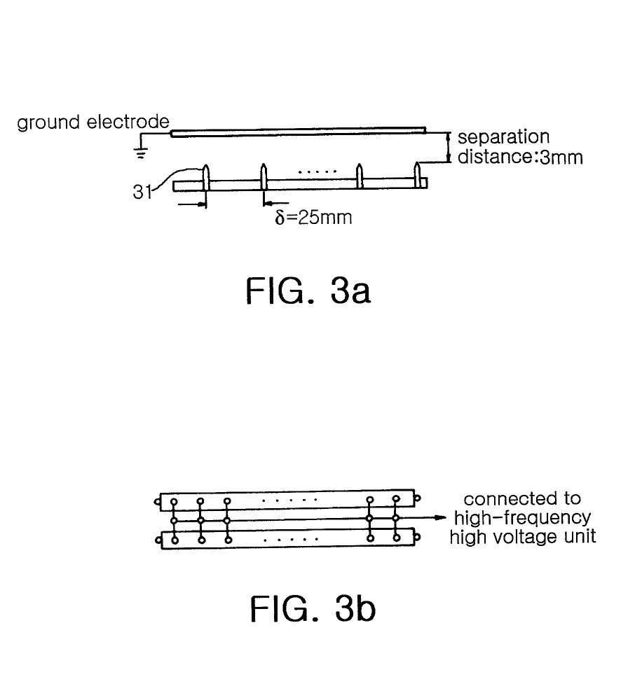

As shown in FIGS. 3a and 3b, each of the first and second discharge assemblies 12a and 12b of the air-blowing type static electricity removal apparatus 10 has 8 needle-shaped electrodes 31 aligned with each other at intervals of, preferably, about 25 mm. The first and second discharge assemblies 12a and 12b may preferably be positioned in such a manner as to be opposed to each other such that ions generated from each of the needle-shaped electrodes 31 are effectively moved to the charged objects 14 by air flow from the fan 11 to the charged objects 14.

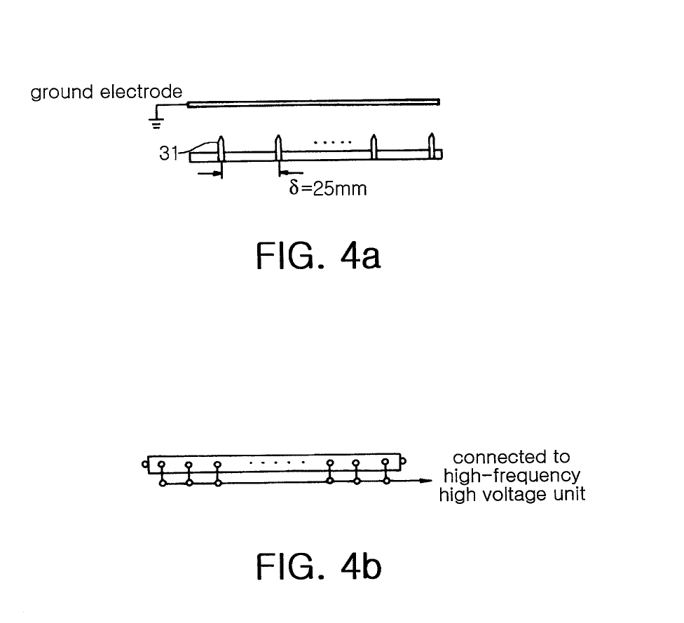

As shown in FIGS. 4a and 4b, the discharge electrode assembly 21 of the bar type static electricity removal apparatus 20 has 30 needle-shaped electrodes 31 aligned with each other at intervals of about 25 mm.

The needle-shaped electrodes 31 are spaced apart from each other at intervals of preferably about 20˜30 mm, most preferably about 25 mm, for the purpose of achieving the maximum ion generation amount and preventing a spark discharge there between.

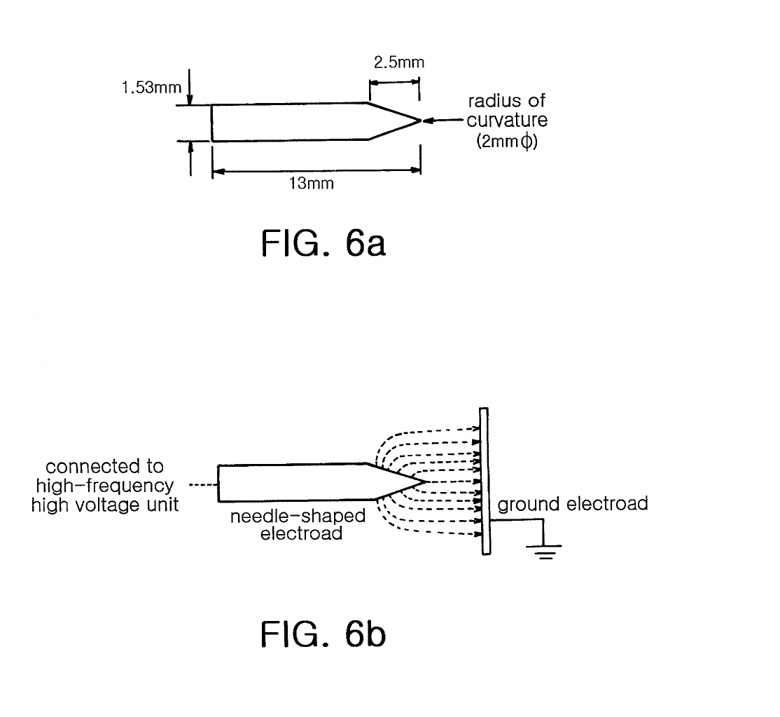

Each of the needle-shaped electrodes 31 included in each of the discharge electrode assemblies 12a, 12b and 21 has a length of 13 mm and a diameter of 1.53 mm, as shown in FIG. 6a, and is made from tungsten (99.95% ). In order to optimize an ion generation amount and ion generation range, it is preferable that the end of each of the needle-shaped electrodes 31 has a radius of curvature of 2 mm.

If the high-frequency high AC voltage from the high-frequency high voltage generation unit 13a, 13b or 22 is applied to the corresponding needle-shaped electrodes 31 having the above described shape, distribution of lines of electric force is formed in the neighborhood of each of the needle-shaped electrodes 31, as shown in FIG. 6b.

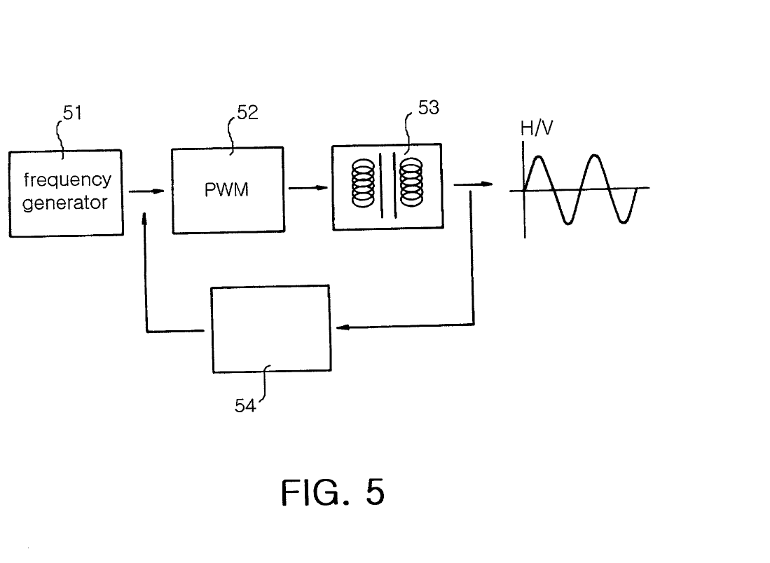

FIG. 5 is a block diagram showing the construction of the high-frequency high voltage generation unit 13a, 13b or 22 for applying the high-frequency high AC voltage to the corresponding discharge electrode assembly 12a, 12b or 21.

The high-frequency high voltage generation unit provided in the present invention includes a frequency generator 51 for generating a high frequency signal having a predetermined frequency (for example, 17 KHz) a pulse width modulation circuit 52 for generating a pulse signal on the basis of the high frequency signal from the frequency generator 51, a high voltage generation circuit 53 for boosting the voltage level of the pulse signal from the pulse width modulation circuit 52 to a predetermined voltage level, generating a high-frequency high AC voltage signal and outputting the generated high-frequency high AC voltage signal, and an ion balance circuit 54 for inputting the high-frequency high AC voltage signal fed back from the high voltage generation circuit 53 and providing the pulse width modulation circuit 52 with a compensation value according to an output variation of the high-frequency high AC voltage signal outputted from the high voltage generation circuit 53.

When inputting a compensation signal, or the compensation value, from the ion balance circuit 54, the pulse width modulation circuit 52 adjusts a pulse width of its output pulse signal on the basis of a high frequency signal from the frequency generator 51 in consideration of the compensation signal.

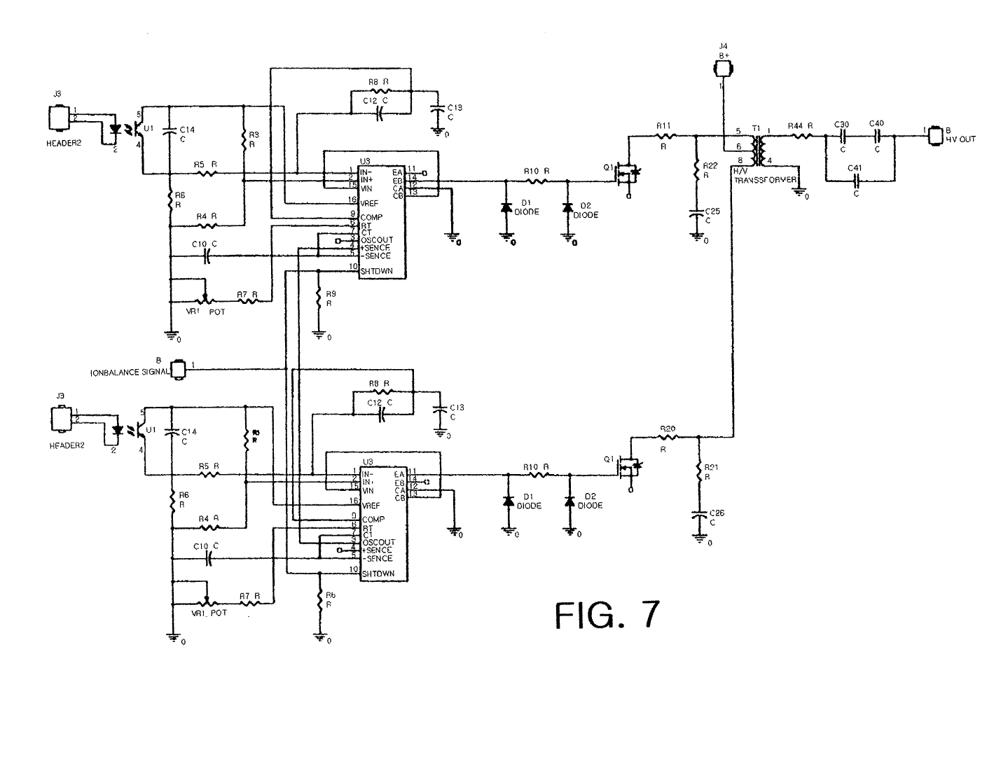

FIG. 7 is a detailed circuit diagram illustrating an embodiment of the pulse width modulation circuit 52 and high voltage generation circuit 53. First, headers 1 and 2 J3 are simultaneously provided with high frequency signals from the frequency generator 51. Then, the headers 1 and 2 J3 respectively apply the provided high frequency signals to upper and lower PWM ICs U3 as a clock signal of a certain period through associated photo couplers U1. At this time, the upper and lower PWM ICs U3 are respectively provided with (+) pulse signal and (−) pulse signal from the headers 1 and 2. Then, the upper and lower PWM ICs U3 transfer the provided (+) pulse signal and (−) pulse signal to a transformer T1, respectively. If the (+) pulse signal and (−) pulse signal is applied to the transformer T1, then the transformer T1 outputs a high-frequency high AC voltage through its secondary coil. The high-frequency high AC voltage signal generated in this manner is applied to each of the needle-shaped electrodes of each of the discharge electrode assemblies 12a and 12b or of the discharge electrode assembly 21, so that ions are generated at a high alternation rate as shown in FIG. 6.

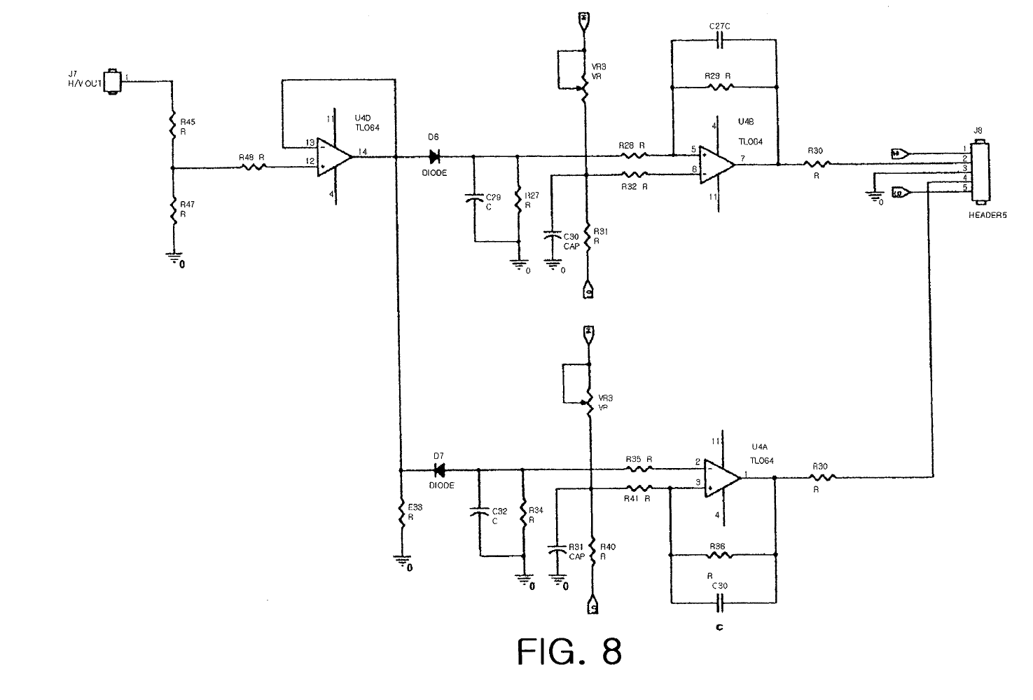

FIG. 8 is a detailed circuit diagram illustrating an embodiment of the ion balance circuit 54. The ion balance circuit 54 inputs the high-frequency high AC voltage signal through its input terminal J7 connected to an output terminal of the high voltage generation circuit 53. Then, the high-frequency high AC voltage signal inputted to the ion balance circuit 54 is applied to an operational amplifier U4D and then amplified by it. Subsequently, a (+) input terminal of an operational amplifier U4B inputs the amplified AC voltage signal, and a (−) input terminal thereof inputs a reference voltage. The AC voltage signal inputted to the amplifier U4B is integrated by an integration circuit including the operational amplifier U4B and passive elements R29, R30, C27, C30 and so forth. The integrated AC voltage signal is then applied to the pulse width modulation circuit 52 to be used as a compensation signal.

It should be noted that the circuit diagrams of FIGS. 7 and 8 have been taken as examples of circuit configurations for generating the high-frequency high AC voltage signal and the present invention is not limited to these.

As described above, a high-frequency high AC voltage signal generated by the high-frequency high voltage generation unit is applied to the discharge electrode assembly such that a corona discharge occurs around each of the needle-shaped electrodes of the discharge electrode assembly to generate ions. The ions generated in this manner is moved to the charged objects by the wind (a maximum of 0.87 m³/min) from the fan or by air pressure (a maximum of 5 kg/cm³) generated by air injection from the air inlet, and bound to ions causing static electricity on a surface of each of the charged objects, thereby removing the static electricity.

The AC voltage applied to the discharge electrode assembly has a high frequency of 17 KHz. Accordingly, an alternating rate at which the ions are generated becomes high. As a result, the static electricity on the charged objects can be rapidly removed even though each of the charged objects moves at a high speed (a maximum of 50 m/sec).

As apparent from the above description, the present invention provides a static electricity removal apparatus which is capable of raising an alternating rate of ion generation by applying a voltage of a high frequency to a discharge electrode, thereby effectively removing static electricity occurring on charged objects moving at high speeds

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A static electricity removal apparatus comprising:
at least one discharge electrode assembly including a plurality of needle-shaped electrodes aligned with each other, each of the needle-shaped electrodes generating ions using a corona discharge under the condition that it is provided with a high-frequency high AC voltage;
a ground electrode spaced apart from the discharge electrode assembly at a certain interval, the ground electrode inducing ion generation by each of the needle-shaped electrodes under the condition that the discharge electrode assembly is provided with the high-frequency high AC voltage; and
a high-frequency high voltage generation unit connected to the discharge electrode assembly, the voltage generation unit generating the high-frequency high AC voltage to be provided to each of the needle-shaped electrodes of the discharge electrode assembly.

2. The apparatus as set forth in claim 1, wherein the high-frequency high voltage generation unit includes:
a frequency generator for generating a high frequency signal of a predetermined frequency band;
a pulse width modulation circuit for generating a pulse signal on the basis of a high frequency signal from the frequency generator and adjusting a width of the pulse signal according to a compensation signal;
a high voltage generation circuit for generating the high-frequency high AC voltage by boosting the voltage level of the pulse signal from the pulse width modulation circuit and providing the generated high-frequency high AC voltage to the discharge electrode assembly; and
an ion balance circuit for inputting the high-frequency high AC voltage fed back from the high voltage generation circuit, generating the compensation signal by integrating the fed back AC voltage, and providing the generated compensation signal to the pulse width modulation circuit.

3. The apparatus as set forth in claim 1, further comprising a fan positioned behind the discharged electrode assembly, the fan generating air flow such that the ions generated from each of the needle-shaped electrodes are moved to charged objects by the generated air flow.

4. The apparatus as set forth in claim 1, further comprising an air chamber of a desired volume arranged behind the discharge electrode assembly while having an air inlet so that air of a predetermined pressure is supplied through the air inlet into the air chamber to move the ions generated from each of the needle-shaped electrodes to charged objects.

5. The apparatus as set forth in claim 1, wherein the apparatus has two discharge electrode assemblies arranged in such a manner as to be opposed to each other.

6. The apparatus as set forth in claim 1, wherein the plurality of needle-shaped electrodes aligned with each other and spaced at intervals of about 20 to 30 mm.

7. The apparatus as set forth in claim 1, wherein an end of each of the needle-shaped electrodes has a radius of curvature of about 2 mm.
